(19) United States
(12) Patent Application Publication
(10) Pub. No.: US 2010/0012714 A1
(43) Pub. Date: Jan. 21, 2010

(54) ENVIRONMENTALLY CONSCIOUS, SOCIALLY RESPONSIBLE GREETING CARD WITH INTEGRATED GIFT

(76) Inventor: Kelly Weesner, Hendersonville, NC (US)

Correspondence Address: STAAS & HALSEY LLP, SUITE 700, 1201 NEW YORK AVENUE, N.W., WASHINGTON, DC, 20005, US

(21) Appl. No.: 12/502,835

(22) Filed: Jul. 14, 2009

Related U.S. Application Data
(60) Provisional application No. 61/080,872, filed on Jul. 15, 2008.

(51) Int. Cl. G06F 17/00; G06Q 40/00; G06Q 10/00; G06Q 50/00; G06Q 20/00; G06Q 30/00; G06K 19/06

(52) U.S. Cl. 235/375; 705/41; 705/30; 705/17; 235/494

(57) ABSTRACT

An environmentally responsible, socially conscious greeting card that integrates a gift via imprinted bar code or 2D-code which allows recipient to obtain the gift by scanning at specified retail partner's location or by entering the redemption code on a partner's website. These multi-occasion cards can be sold at a national retailer's point of purchase or on their website, activated and registered as a sale at the time of purchase.

### CROSS-REFERENCE TO RELATED APPLICATIONS

This application claims priority to U.S. Provisional Patent Application No. 61/080,872, filed Jul. 15, 2008, the contents of which are hereby incorporated by reference.

### BACKGROUND

1. Field

The embodiments discussed herein relate in general to greeting cards and, more specifically, to an environmentally conscious, socially responsible greeting card that can integrate a gift embedded via scannable code which the recipient may redeem for item(s) predetermined by the specified retail partner at partner location(s) or on their website. As an alternative to a traditional gift card, the greeting card can allow the specified retail partner to record revenue at a time of purchase rather than redemption and avoid potential escheatment.

2. Description of the Related Art

Although the custom of sending greeting cards can be traced back to the ancient Chinese, who exchanged messages of good can to celebrate the New Year, the American greeting card is a mere 153 years old. The card has evolved from a highly complex work of art reserved exclusively for Christmas to present days' ever increasing popularity of non-occasion cards.

It is now considered common practice for senders to accompany greeting cards with a separate gift—frequently a gift card. Senders that include a gift card enclose a separate plastic card issued by a third party retailer, $80 billion of which were sold in 2006. The recipient of the gift card may then redeem the card for goods or services at the specified vendor.

### SUMMARY

An environmentally responsible, socially conscious greeting card system that integrates a gift via imprinted bar code, 2D-code or other scannable code which allows a recipient of the card to obtain the gift by scanning into a cash register type system at retail partner's location or by entering a redemption code of the scannable code on partner's website. The multi-occasion cards can be sold at a national retailer's point of purchase or on their website, activated and registered as a sale at the time of purchase.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is the front of the greeting card and contains specified retail partners design of choice.

FIG. 2 is the back of the greeting card which contains the following: general greeting, space for personalized message, verbal gift directive, mention of charitable contribution and environmental commitment, embedded scannable code for specified retail partner to scan OR redemption code for recipient to enter at partner website and address/postage.

FIG. 3 details the process of purchasing and redeeming the greeting card.

FIG. 4 reflects the relationship between the scanner, cash register and specified retail partners database.

FIG. 5 depicts operation flow in the system.

### DETAILED DESCRIPTION

The embodiments discussed herein are intended to provide greeting card consumers the ability to simultaneously purchase a greeting card and a gift, which is embedded via a scannable code, such as a barcode or 2D code, like a Vericode®, that allows the recipient to redeem for item(s) predetermined by the specified retail partner at partner location(s) or on their website. Although single use would be the most probable method utilized, the specified retail partner may choose to create a multitude of customized programs according to their needs—ie greeting card featuring one gift item per month for a year.

The card is the first environmentally conscious, socially responsible greeting card and in alignment with the “greening” of America that allow consumers to reduce their carbon footprint in a multiplicity of ways.

From an environmental perspective, the card is be printed on recycled materials with vegetable, soy-based or other non-toxic inks. In addition, the embedded scannable code eliminates the need for plastic production and the supplemental transportation typically required to purchase a plastic gift card. Furthermore, since the card can be redeemed at the specified retail partner, it can be recycled as opposed to the 7 billion greeting cards that typically end up in landfills annually.

Looking beyond convention, the card can make a social statement by honoring the recipient with a donation to the specified retail partners preferred charity. Moreover, as the world becomes smaller and an individual's personal network continues to grow, the greeting card/gift offers a time sensitive, value-oriented solution to the insurmountable challenge of recognizing all the friends, clients and acquaintances that one would be inclined to observe.

Furthermore, of importance to the specified retail partner, particularly in the current economic climate, the card can have the (optional) ability to record revenue at the time or purchase rather than later at the time of redemption.

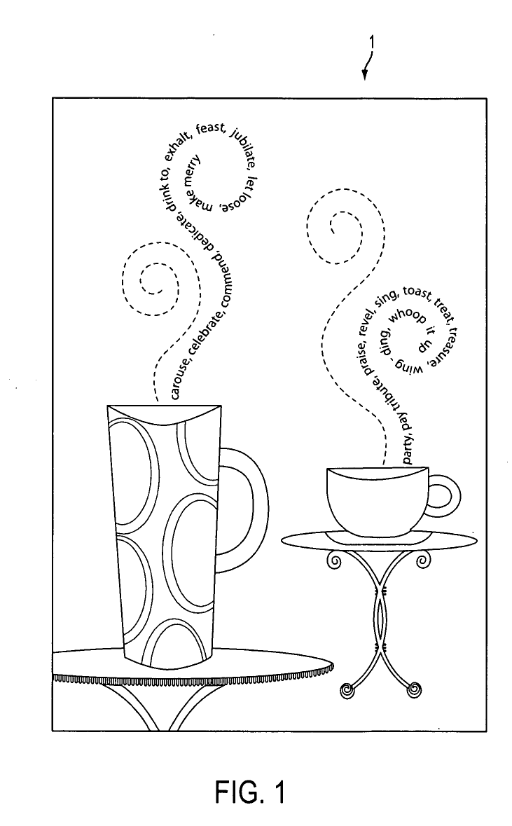

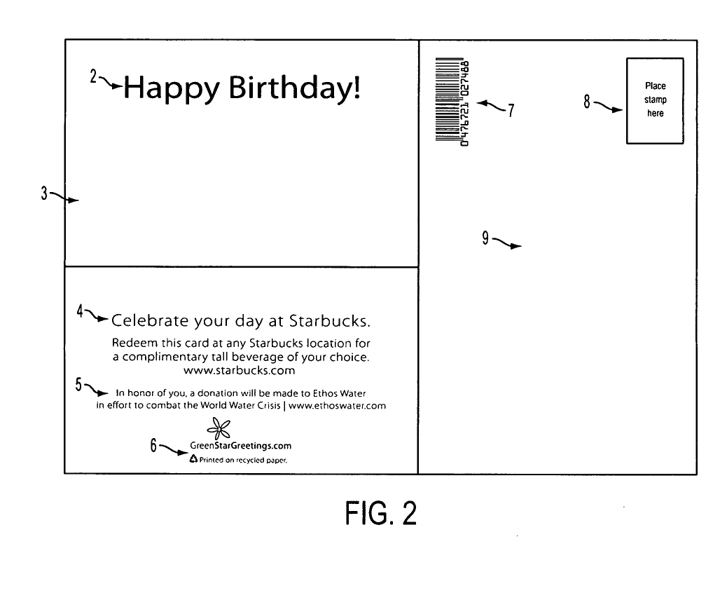

Referring to the drawings, an environmentally conscious, socially responsible greeting card with integrated gift is shown in FIGS. 1-2. In addition to being printable on recyclable materials, the front panel 1 can utilize environmentally friendly inks which may be soy-based, vegetable or other non-toxic options. The art design on the front panel is conceptual in that the specified retail partner can utilize in-house artwork that reinforces their brand with consumers.

A general greeting 2 can capture the recipient's attention with a variety of all occasion messages such as Happy Birthday, Thank You, Merry Christmas etc. A space 3 for personalized inscription immediately follows. Test 4 for verbalization of the gift and redemption directions directs recipient to specified retail partner's location or website to receive their gift. The sender also can honors recipient with a charitable contribution 5 to retail partner's preferred charity. A nationally recognized recycling icon 6 can showcase environmental commitment.

The scannable code 7, such as the bar code—redemption code shown, includes an indentifying code, which is either entered for redemption on partner's website OR activated via scan 20 by the specified retail partner at point of purchase. An area 8 for a postal stamp is indicated along with space 9 for the sender to address to the card's recipient.

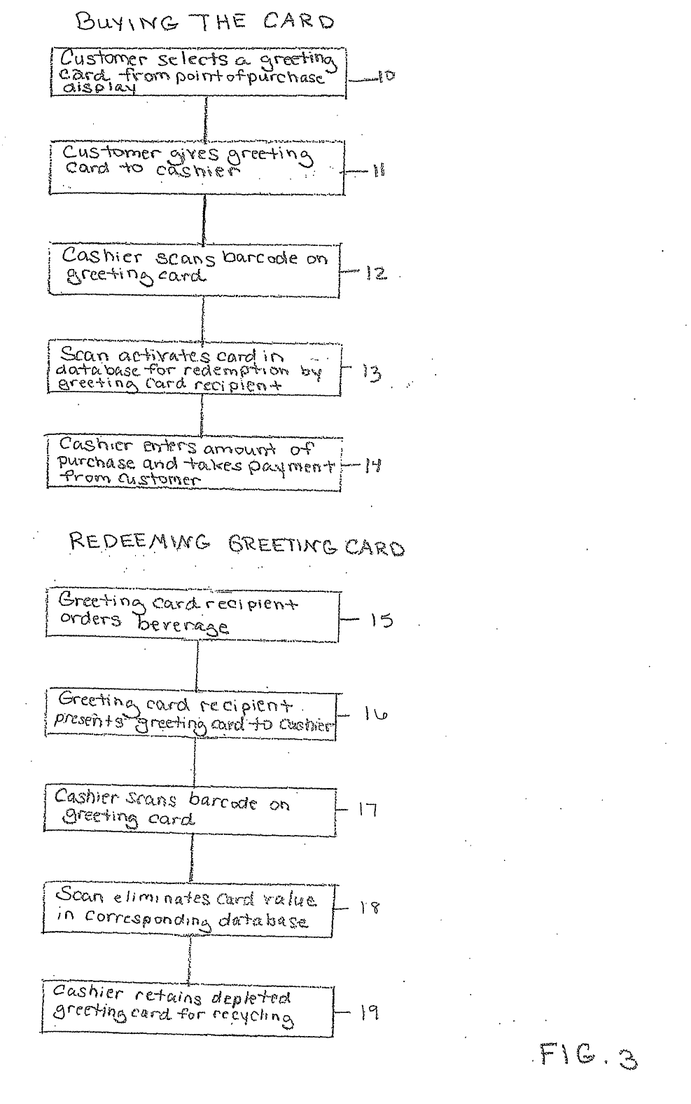

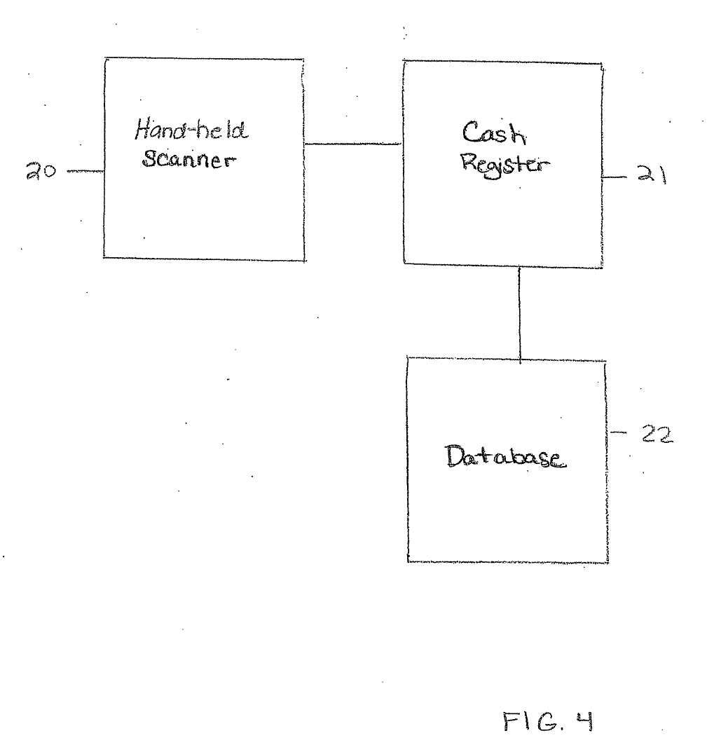

FIG. 3-4 details the process in which the greeting card can be purchased and redeemed at retail partner's location. A customer selects 10 a greeting card 1 of their choice from the specified retail partner's point of purchase display. The customer proceeds to the cash register and presents 11 the card to the cashier. The cashier picks up the hand held scanner 20 and scans the code 7 on the greeting card 12. The scan activates 13 an account corresponding to the card in the retail partner's database 22 (see FIG. 4) allowing for future redemption by the greeting card recipient The cashier enters 14 an amount of purchase into the cash register 21 and takes payment from the customer and the system can enters the amount as a value (or credit) for the future redemption into the database 22 when the card is to have a monetary redemption value. When the card is to correspond to a specific gift, such as a small cup of coffee, a gift item identifier is entered into the database Unlike a traditional gift card, the cash register records the “sale” of the greeting card/gift at time of purchase rather than at redemption. The customer then writes a personalized inscription 3, addresses the card 9 and places a postage stamp 8 to be mailed via the U.S. postal service.

When the greeting card recipient (or holder) receives the card, they may take it 15 to any of the specified retail partner's locations to receive the gift indicated on the greeting card. The customer can present 16 the greeting card/gift to the cashier. The cashier can in turn utilize the hand held scanner 20 of the cash register 21 to scan 17 the code 7 on the greeting card. The system obtains the redemption amount or credit or gift identifier from the database 22 corresponding to the scanned code and credits the purchaser with the redemption amount in the cash register 21. Any additional monies for the purchase are collected from the customer to complete the sale. Any unused redemption amount remains recorded in the database for future redemption When there is no money left or when the card is for a specified gift, like the small cup of coffee example discussed above, the operation can deactivate 18 the card in the database 22 of the specified retail partner making it invalid for future use (unless of course, a customized program warranting future use has been created by the specified retail partner). The customer receives their gift/purchased item 19 and the cashier can retains the deactivated greeting card for recycling.

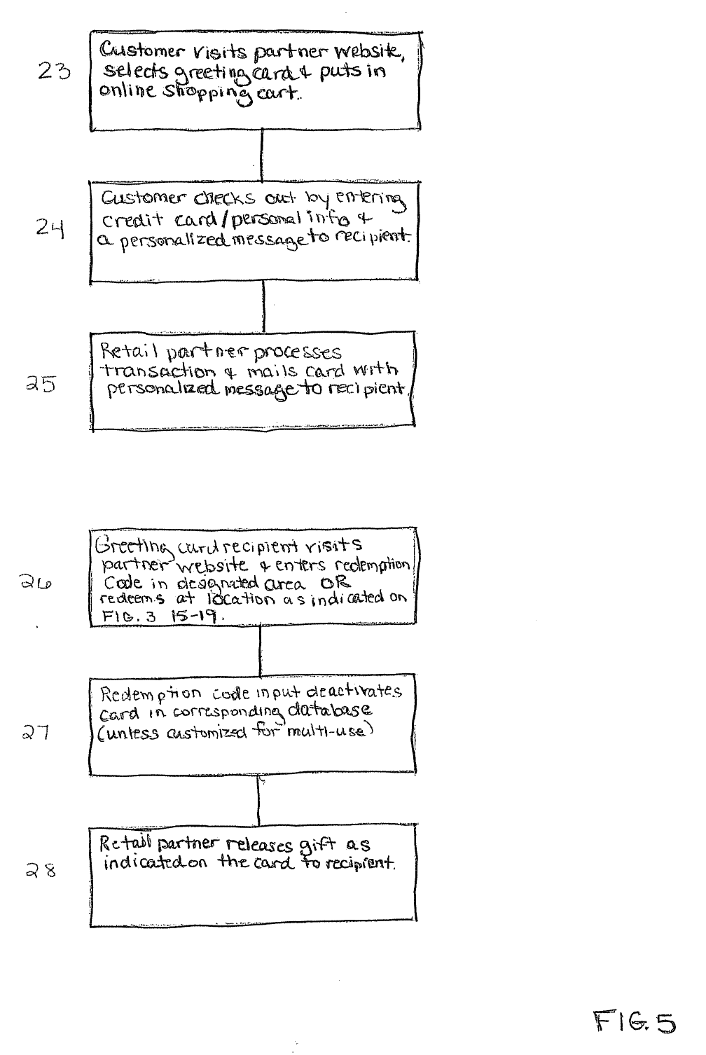

FIG. 5 details the process in which the greeting card can be purchased and redeemed on partner's website. Customer visits 23 the partner website, selects a greeting card 1 of their choice and puts in online shopping cart. The customer proceeds 24 to online checkout, enters personal info, credit card and personalized message to the recipient. The retail partner processes 25 the online transaction which activates the redemption process (see above) corresponding to the card in the retail partner's database 22 which in turn, allows for redemption by the greeting card recipient. Unlike a traditional gift card, the on-line cash register records the sale of the greeting card/gift at time of purchase rather than at redemption

When the greeting card recipient receives the card, they may visit 26 the partner's website and enter the redemption code in designated area OR redeem at partner's physical location as indicated on FIG. 3 15-19. The redemption code can deactivate 27 the card in the database 22 of the specified retail partner, as discussed above, making it invalid for future use (unless of course, a customized program warranting future use has been created by the specified retail partner). The retail partner releases 28 the gift to the recipient instantly or according to type of gift integrated by retail partner.

As discussed above and shown in FIG. 1, the greeting card can be a post card type greeting card. In an alternative, the card could be in the form of a traditional envelope type greeting card where the card can have a fold defining an inside and an outside of the card and be inserted into an addressable envelope. The greeting could be on the outside and inside and the code (scan able code or human readable redemption code) also on the inside of the card with the redemption directions. If the cash register of the retailer selling and charging/loading the card with money or a specific gift has printing capability, the card, after the code has been correlated to the value, can have the value (monetary or specific gift) printed on it. The card, rather than being customized for each purchaser/recipient at the time the card is purchased, can also be mass produced by a particular retailer with the value in the form of a specific gift, such as a cup of coffee or specific valuation, assigned to the code of the cards before the card is placed in the retailer store for sale as a gift card. It is also possible to make the part of the card that has the code (and redemption instructions) part of a coupon that can be detached from the card along a perforation line, so that the coupon (gift) can be detached and presented to the redemption retailer and the part of the card with the greeting kept by the card recipient.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over a transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A system, comprising:
a greeting card having a scannable/human readable code thereon; and
a retail system for accepting the code, assigning a redemption indicator to the card when purchased by a purchaser and crediting the redemption indicator to a purchase when the card is presented for the purchase by a holder of the card.

2. A system as recited in claim 1, wherein the redemption indicator comprises one of a monetary value and a particular item.

3. A system as recited in claim 1, wherein the retail system comprises:
a hand held scanner scanning the code;
a cash register recording the monetary value; and
a database recording the code and the corresponding redemption indicator.

4. A system as recited in claim 1, wherein the card comprises:
a greeting; and
redemption directions.

5. A system as recited in claim 3, wherein the card further comprises a donation indicator indicating where a donation monetary value is donated.

6. A system, comprising:
a greeting card comprising:
a printable substrate;
a greeting printed on the substrate;
a donation indicator printed on the substrate indicating where a donation monetary value is donated;
an address region designated on the substrate; and
a scannable code printed on the substrate and corresponding to a monetary redemption value of the card; and
a retail system for scanning the code, assigning the redemption value to the card when purchased by a purchaser and crediting the redemption value to a purchase when the card is presented for the purchase by a holder of the card, retail system comprising:
a hand held scanner scanning the code at a time of purchase of the card at a retailer and scanning the scannable code on the card at a time of redemption;
a database for recording the code and the corresponding monetary value; and
a cash register recording the monetary value in the database, crediting the retailer with a sale for the redemption value and providing a presenter of the card with a credit for a purchase corresponding to the redemption value at a time an item is purchased from the retailer.

7. A process, comprising:
scanning a scannable code on a greeting card at a time of purchase of the card at a retailer;
storing a redemption value of the card corresponding to the code in a database;
crediting the retailer with a sale for the redemption value at the time of the purchase of the card at the retailer;
scanning the scannable code on the card at a time of redemption; and
providing a presenter of the card with a credit for a purchase corresponding to the redemption value at a time an item is purchased from the retailer.

8. A card, comprising:
a printable substrate;
a greeting printed on the substrate;
an address region designated on the substrate; and
a scannable code printed on the substrate and corresponding to one of a specific gift item and a monetary redemption value of the card.
